(19) United States
(12) Patent Application Publication
(10) Pub. No.: US 2022/0296941 A1
(43) Pub. Date: Sep. 22, 2022

(54) Firefighter Respirator Mask Device

(71) Applicant: Brian Greene, Wood Ridge, NJ (US)

(72) Inventor: Brian Greene, Wood Ridge, NJ (US)

(21) Appl. No.: 17/564,619

(22) Filed: Dec. 29, 2021

Related U.S. Application Data
(60) Provisional application No. 63/163,101, filed on Mar. 19, 2021.

(51) Int. Cl. A62B 23/02

(52) U.S. Cl. CPC A62B 23/025; A62B 18/02

(57) ABSTRACT

The present invention relates to the field of firefighter facial masks. More specifically, the present invention relates to a firefighter respirator mask device that is preferably comprised of a body, a facial covering over an opening of an SCBA mask, a fastening mechanism and a filter. The body of the device preferably resembles an ovular shape, or any shape that sufficiently covers the hole left over the mouth of an SCBA mask when not attached to an oxygenated hose, normally present under hazardous conditions. The device is comprised of color-changing technology that allows the facial mask to turn colors in response to pathogenic exposure, indicating to the user that it is no longer sterile. In this manner, the device can be applied to any firefighter or industrial worker requiring the use of an SCBA without risk of possible pathogenic exposure when not attached to an oxygenated hose.

### CROSS-REFERENCE TO RELATED APPLICATION

The present application claims priority to, and the benefit of, U.S. Provisional Application No. 63/163,101, which was filed on Mar. 19, 2021 and is incorporated herein by reference in its entirety.

### FIELD OF THE INVENTION

The present invention relates generally to the field of firefighter facial masks. More specifically, the present invention relates to a firefighter respirator mask device that is comprised of a body, a facial mask covering that may attach to a self-contained breathing apparatus (SCBA) mask, and in certain embodiments, a filter. The body of the device preferably resembles an ovular shape, more specifically a shape that sufficiently extends over the mouthpiece opening of an SCBA entirely, and is made of a flexible, breathable and disposable or reusable material. In one embodiment, the device is non-disposable and is also comprised of a filter that may be exchanged in response to pathogenic exposure. In one embodiment, the device is disposable and is also comprised of a filter that may be exchanged in response to pathogenic exposure. In another embodiment, the device is disposable with a built-in filter, and should be exchanged entirely in response to pathogenic exposure. Any of the embodiments may be secured with an adhesive, elastic, or fastening attachment to the SCBA mask, and may feature one or all of these attachment mechanisms as to ensure secure attachment to the SCBA mask during possibly physically straining activity. In this manner, the device can be worn by any firefighter or adjacent profession requiring the use of an SCBA mask to protect the user and others from the possible transmission of viruses, bacteria and other pathogens when the SCBA mask is worn without total coverage of the mouth and nose area. Accordingly, the present disclosure makes specific reference thereto. Nonetheless, it is to be appreciated that aspects of the present invention are also equally applicable to other like applications, devices and methods of manufacture.

### BACKGROUND

Firefighters are required to wear facial masks known as self-contained breathing apparatus (SCBA) masks while on duty. These masks are designed to provide breathable air in an atmosphere that is otherwise dangerous to life or health, and are often used in adjacent industries such as mining or chemical industries. However, each SCBA mask is designed with a hole located near the mouth and nose that exists to for the purpose of attaching to an air hose, which attaches to an oxygen tank to allow the user to breathe clean air in hazardous conditions. Therefore, if a firefighter or industrial worker desires to wear an SCBA mask without the oxygen hose attached to his or her mask, his or her mouth and nose are exposed to the atmosphere, which could potentially introduce the possibility of transmitting viruses, bacteria or pathogens. Currently, there are no convenient solutions to cover the opening of an SCBA mask, thus leaving the wearer and those around the wearer susceptible to disease transmission. Moreover, even if such a solution exists, there is currently no way to know when it is a proper time to exchange a mask or filter for a new mask, as there is no mechanism to indicate pathogenic exposure. This leaves the timely exchange of respirator filters or masks up to chance, which could have potentially lethal consequences.

Therefore, there exists a long-felt need in the art for an improved firefighter respirator mask device. There also exists a long felt need in the art for a firefighter respirator mask that protects firefighters and other industrial workers from possible virus, bacteria, and pathogen transmission. Further, there exists a long-felt need in the art for a firefighter respirator mask that covers the nose and mouth of users not presently breathing through an oxygen hose but that may still be wearing an SCBA mask. In addition, there exists a long felt need in the art for a firefighter respirator mask device that may be easily applied and disposed of, so that the exchange of firefighter respirator masks may be convenient to a user in an environment where exposure to hazardous air may pollute the device quickly and repetitively. Additionally, there exists a long felt need in the art for a firefighter respirator mask that signals to the user that the mask should be disposed of and replaced due to pathogen exposure via a change in color, and for a mask that is resistant to the possible damages of the environment it is being used in, such as fire.

The subject matter disclosed and claimed herein, in one embodiment thereof, comprises a firefighter respirator mask device. The device is comprised of a body, a facial mask covering that extends over the opening of an SCBA mask where an oxygenated hose would normally be under hazardous conditions, a fastening mechanism, and in certain embodiments, an exchangeable filter. The body of the device preferably resembles an ovular shape, or one that fits sufficiently over the hole of an SCBA mask and features straps that extend far enough to be secured by the SCBA masks filter covers. The device is also comprised of an adhesive layer, an elastic band, and a plurality of fastening mechanisms to ensure proper sealing from the exposed air. The device is also comprised of color-changing technology that is capable of sensing pathogenic exposure and changing colors in response as to indicate to the user that the mask covering is no longer sterile, and ought to be changed. Further, the device is flame retardant and acid resistant. In this manner, the device can be worn by any user of an SCBA mask while they are not breathing through an oxygenated hose without risk of possibly harmful pathogenic exposure.

In this manner, the firefighter respirator mask device of the present invention accomplishes all of the forgoing objectives and provides an improved means of protection against airborne viruses, bacteria or pathogens for firefighters and industrial workers wearing an SCBA mask, but not actively breathing through an oxygen hose. Further, the device is conveniently attachable to the SCBA mask in a plurality of ways including, but not limited to, adhesion, strap, fastener, etc., for convenient exchange of disposable coverings and filters. In addition, the device is securely attachable to the SCBA mask in a plurality of ways that comfortably seal the user from possibly disease-transmittable air. Additionally, the device changes color to indicate to the user that it has exceeded its maximum capacity for particulate collection and must be disposed of and exchanged and is resistant to fire to avoid damage to the device and user.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a firefighter respirator mask device that covers the front hole of an SCBA mask when said hole is not occupied by an oxygen hose. The body of the device further changes color from green to red when exposed to pathogens to indicate that the device is no longer sterile. The device is also preferably flame-retardant and acid-resistant, may be easily removed from an SCBA mask, and may contain an exchangeable filter. In this manner, a firefighter or any other industrial worker that uses an SCBA mask may be protected from pathogenic, virus and bacteria transmission while wearing an SCBA mask but not actively breathing through an oxygen hose attached to the mask.

The device is primarily comprised of a body, that cover the mouthpiece hole of an SCBA mask, a fastening mechanism, and in certain embodiments, an exchangeable filter. The body is preferably oval in shape, or may be any shape that may sufficiently covers the hole of the mouthpiece of an SCBA mask. The body may be made of a variety of materials that allow for breathable, flexible and protective use in hazardous conditions, that also are coated or intwined with flame-retardant and acid-resistant treatment or compounds. Additionally, the material of the body features color-changing properties that allows the body to change colors in response to pathogenic, viruses or bacteria exposure. Furthermore, the front surface of the body may be comprised of a plurality of indicia such as patterns, logos, emblems, images, symbols, designs, letters, words, characters, animals, advertisements, brands, etc. that may or may not be fire, chemical or industrial work-related.

The body also has an adhesive feature that may become active at the removal of a peelable backing for non-disposable embodiments of the device, thus allowing for simple attachment and removal of the device from the mouthpiece of an SCBA mask. Additionally, the body has at least two straps attached to it that may loop around the filter covers of an SCBA mask that are preferably made of elastic and may be further secured by an attachment mechanism included but not limited to an adhesive, magnetic, or hook and loop. In addition, one or all embodiments of the device may be comprised of an elastic band within the body that allows the body to fit the dimensions of the perimeter of the mouthpiece of the SCBA mask, similar to how a fitted bed sheet fits a bed. In this manner, maximum fastening measures are taken to ensure secure attachment of the device to the SCBA mask.

Further, the device features color-changing properties that enables it to turn from green to red (or from a first color to a second color) in response to pathogenic, virus, or bacteria exposure, indicating that the device is longer sterile and either the filter within the body or the body and the entire device itself must be removed or exchanged. To ensure safe and easy removal of the filter, a small tag exists as a protrusion from the pocket where the filter is kept inside of the mask, so it may be simply pulled out without having to encounter the pathogenic exposed portion of the filter. The filter is preferably a chemical-sensing paper cloth that is capable of detecting pathogens and may be treated with a variety of color-changing treatments including but not limited to phage-displaying trinitrotoluene (TNT) binding peptide motifs, or any other color-changing technology to indicate to the user that the presence of a pathogen has been detected at some threshold amount and should be exchanged for a new filter or mask.

Accordingly, the firefighter respirator mask device of the present invention is particularly advantageous as it allows a firefighter to or any industrial worker requiring the use of an SCBA mask to wear his or her mask without the oxygenated hose normally attached to it under hazardous conditions, without risking exposure to possibly dangerous airborne pathogens. In addition, the device can be attached to the SCBA mask in a plurality of ways that ensure safe and secure sealing from the exposed air. Further, upon exposure to a pathogen, the device changes color to indicate to the user that it is no longer sterile, preventing a user from harmfully breathing in trapped bacteria or viruses through the mask. Additionally, the device is flame-retardant and acid-resistant as to not risk unwanted damage that may be common in the environments users may normally be exposed to, wherein said environments may be on fire. In this manner, the firefighter respirator mask device overcomes the limitations of existing masks known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a firefighter respirator mask device of the present invention in accordance with the disclosed architecture;

FIG. 2 illustrates a rear perspective view of one potential embodiment of a firefighter respirator mask device of the present invention in accordance with the disclosed architecture; and

FIG. 3 illustrates a perspective view of one potential embodiment of a firefighter respirator mask device of the present invention while attached to a SCBA mask (shown as prior art) while the SCBA mask is worn by a wearer in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a firefighter respirator mask device that protects firefighters and other industrial workers from the possibility of airborne disease transmission while they are not breathing through an oxygen hose attached to their SCBA mask, and that would otherwise cover the hole in the SCBA mask. Further, there exists a long-felt need in the art for a firefighter respirator mask that may be attached in a plurality of ways to allow for the convenient exchange and disposal of used masks that may be polluted with environmental toxicants. Further, there exists a long felt need in the art for a firefighter respirator mask that is comprised of a flexible and breathable material, such that it may be comfortably worn during possibly strenuous physical exercise while maintaining a sealed protection from airborne pathogens transmission. Additionally, there exists a long felt need in the art for a firefighter respirator mask device that signals to its user when is it is necessary to exchange the present filter or mask for a new, sterile one due to pathogenic exposure.

The present invention, in one exemplary embodiment, is comprised of a firefighter respirator mask device that allows coverage over the hole left in an SCBA mask when the mask is worn but not connected to an oxygen hose that is normally inserted into the mask during hazardous conditions. The device is primarily comprised of a body, a facial mask covering over the hole of an SCBA mask, a fastening mechanism, and in certain embodiments, a filter. The body may have the appearance of an oval-like shape, or any such shape that may perfectly cover and sufficiently seal the user of the SCBA mask from exposed outside air. The body may be made of a plurality of materials that may be commonly used for pathogen protecting facial masks, but is preferably made of a flexible, breathable and toxicant-trapping material. In addition, any surface of the body may be comprised of a plurality of indicia such as patterns, logos, emblems, images, symbols, designs, letters, words, characters, animals, advertisements, brands, etc., that may or may not be firefighter or chemical work-related.

Further, the body has multiple attachment and removal options for secure fastening to an SCBA mask or other mask of the like. These options include but are not limited to: the edges of the mask containing an adhesive seal that may be peeled off at the moment of use, an elastic band entrapping the perimeter mouthpiece of the SCBA mask, in addition to straps that are preferably elastic and are looped, such that they can be removably-attached around the filter covers of the SCBA mask. In differing embodiments, the straps may include at least one fastener such as but not limited to adhesive or magnetic to aid the straps in being retained around the filter covers. In any such embodiment, disposable or non-disposable, the device may feature one, all three or more fastening features to ensure proper sealing from possibly hazardous and unsanitary air.

The material of the device is damage-resistant to the environment in which they may be typically worn (e.g. an environment on fire). As such, the material of the firefighter respirator mask device is acid damage-resistant and flame-retardant, being coated and/or intertwined with materials included but not limited to polytetrafluoroethylene, two component epoxy systems, trichloro-ethylene, triclosan, perchloroethylene, tetrabromobisphenol A, among others. In addition, the material of the device has color-changing properties that detect the presence of pathogens, viruses, and/or bacteria, thus indicating to the user when it is appropriate to exchange filters of the device or the device as a whole. The material of the body may feature phage-displaying trinitrotoluene (TNT) binding peptide motifs, or any other such color-changing technology to indicate to the user that the presence of pathogens, bacteria, and/or viruses that have been detected at some threshold amount.

Accordingly, the firefighter respirator mask device of the present invention is particularly advantageous as it allows an SCBA mask user such as a firefighter or industrial chemical worker to wear the SCBA mask without attachment to an oxygen hose, and still be protected from the transmission of airborne pathogens, viruses and bacteria. The device also allows a user to be notified via color-changing signaling when the device and/or filter should be replaced due to contamination. Therefore, the device eliminates the need for a firefighter or industrial chemical worker to remove the SCBA mask entirely to still be protected from the damages of airborne pathogen.

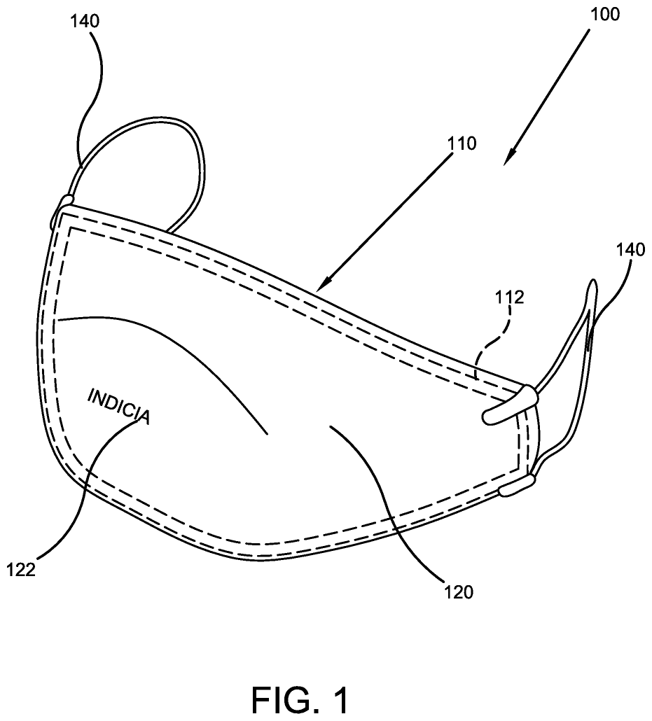

Referring initially to the drawings, FIG. 1 illustrates a front perspective view of one potential embodiment of a firefighter respirator mask device 100 of the present invention in accordance with the disclosed architecture. The device 100 is comprised of a body 110 that is further comprised of an at least one elastic band 112, a front surface 120, a rear surface 130 with an adhesive layer 136 and a peelable backing 138, and at least one strap 140. In differing embodiments, the body 110 may be manufactured from a plurality of materials such as vinyl, canvas, cashmere, chenille, chiffon, damask, jersey, lace, linen, wool, modal, satin, silk, spandex, suede, tweed, twill, velvet, acrylic, modacrylic, nylon, polyurethane, polyvinyl chloride, polyethylene, vinylidene, benzoate, aramid, rayon, acetate, triacetate, etc., but is preferably made of a triune blend of cotton, polypropylene, and a polyester blend, in a disposable embodiment of the body 110. Additionally, any said materials may be infused with flame-retardant and acid-resistant chemical protection, which may include but is not limited to polytetrafluoroethylene, two component epoxy systems, trichloro-ethylene, triclosan, perchloroethylene, tetrabromobisphenol A, among others. In addition, the body 110 will change color in response to pathogen, virus, or bacteria exposure via utilization of phage-displaying trinitrotoluene (TNT) binding peptide motifs, or any other such color-changing technology to indicate to the user that the presence of pathogens, viruses, or bacteria has been detected at some threshold amount, and as such the device 100 and/or a filter 134 within the body 110 should be replaced. Furthermore, the front surface 120 of the body 110 may be comprised of any number of indicia 122 in the form of patterns, logos, emblems, images, symbols, designs, letters, words, characters, animals, advertisements, brands, etc., that may or may not be fire, chemical or industrial work-related.

In the preferred embodiment of the device 100 shown in FIGS. 1,2, and 3, the body 110 is shaped such that it sufficiently covers a mouthpiece opening 12 in an SCBA mask 10 when said opening 12 is not being occupied by an oxygen hose. The body 110 is further comprised of an internal elastic band 112 that helps the body 110 in remaining fastened around the mouthpiece opening 12 of the SCBA mask 10, similar to how the elastic of a fitted bed sheet maintains fixture of the sheet around a bed. At least two straps 140 of the body 110 may be fixedly or removably-attached to the body 110, and are preferably elastic or of any flexible, flame-retardant, and acid-damage resistant material. The straps 140 are looped such that they can be removably-attached around the filter covers 14 of the SCBA mask 10. Any one or all three of the embodiments, either non-disposable with a filter, disposable with a filter or disposable without a filter may include or not include this strapped 140 attachment mechanism.

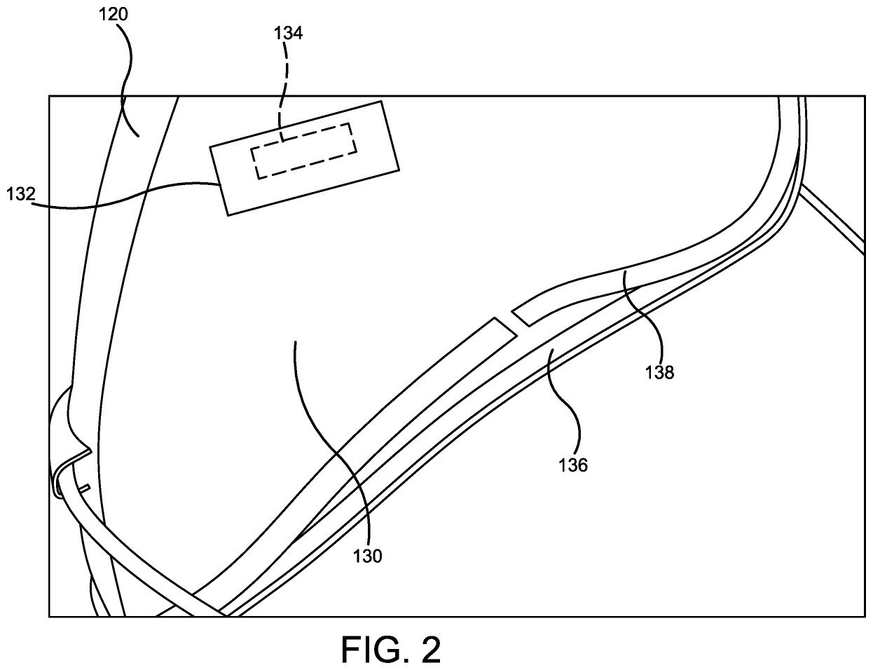

FIG. 2 illustrates a rear perspective view of one potential embodiment of a firefighter respirator mask device 100 of the present invention attached to an SCBA mask 10 in accordance with the disclosed architecture. In addition to the elastic band 112 attachment feature, the device 100 may also feature an adhesive layer 136 that is initially covered with a peelable backing 138 to be removed at the precise moment of use. The adhesive layer 136 is then pressed around the mouthpiece opening 12 of the SCBA mask 10 to secure further the device 100 to the SCBA mask 10. The adhesive layer 136 is located around the perimeter of the rear surface 130. Furthermore, certain embodiments may utilize at least one exchangeable filter 134 that can be placed inside the body 110 and secured by a pocket 132 which may contain one or more openings for simple removal and exchange of the filter 134, indicating to the user that it is time to be exchanged by changing color from green to red (or from a first color to a second color) in response to pathogenic exposure.

In differing embodiments, the filter 134 may be any filter type known in the art such as but not limited to: carbon filters, HEPA filters, etc. To ensure simple removal and exchange, the filter 134 may feature a small tag protrusion on its edge that is not exposed to the outside air, making for simple extraction of the filter 134 without touching the exposed, pathogenic-filled area of it. In disposable embodiments not featuring a filter 134 or pocket 132, the entire front surface 120 of the device 100 changes colors in response exposure to pathogens, viruses, and bacteria, indicating that it is appropriate to get a new mask. The filter 134 as well as the material of the body 110 itself in the disposable, non-removable filter embodiments will be flame-retardant as well as acid-resistant. In addition, one embodiment of the filter 134 may have the same color-changing properties as the body 110.

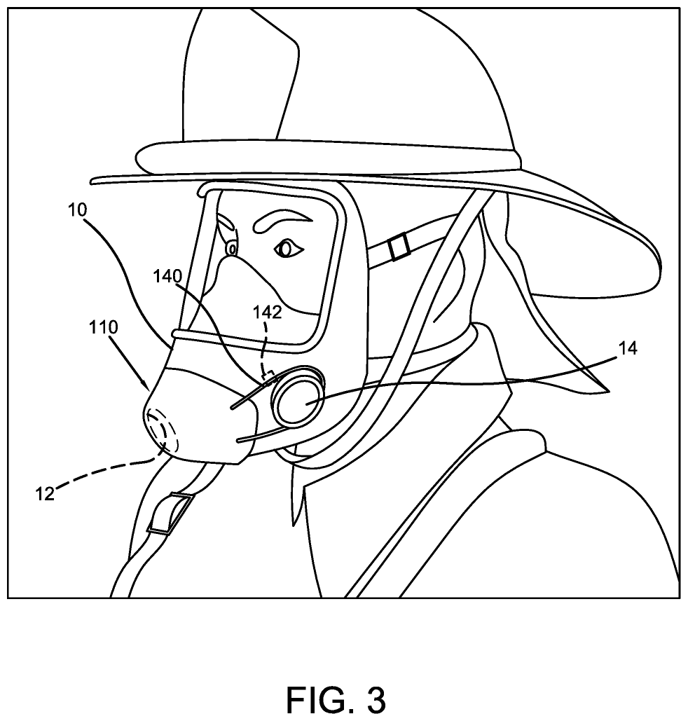

FIG. 3 illustrates a perspective view of one potential embodiment of a firefighter respirator mask device 100 of the present invention while attached to a SCBA mask 10 (shown as prior art) while the SCBA mask is worn by a wearer in accordance with the disclosed architecture. The device 100 is depicted in this figure as being fixedly-attached to the SCBA mask 10 via straps 140 which are looped around the filter covers 14 of the SCBA mask 10. The body 110 further sufficiently covers the mouthpiece opening 12, which would otherwise be covered by an oxygen hose (not shown) when the mask 10 is in use. The body 110 is also depicted as being fixed to the SCBA mask 10 with a fastener 142 mechanism. In one embodiment, the straps 140 may include at least one fastener 142 such as, but not limited to, adhesive, magnetic or hook and loop, to aid the straps in being retained around the filter covers 14. The straps 140 are also flame-retardant and acid-resistant, to avoid unwanted removal of the device 100 from the SCBA mask 10 due to possible hazardous exposure.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “firefighter respirator mask device” and “device” are interchangeable and refer to the firefighter respirator mask device 100 of the present invention.

Notwithstanding the forgoing, the firefighter respirator mask device 100 of the present invention and its various components can be of any suitable size and configuration as is known in the art without affecting the overall concept of the invention, provided that they accomplish the above-stated objectives. One of ordinary skill in the art will appreciate that the size, configuration and material of the firefighter respirator mask device 100 as shown in the FIGS. are for illustrative purposes only, and that many other sizes and shapes of the firefighter respirator mask device 100 are well within the scope of the present disclosure. Although the dimensions of the firefighter respirator mask device 100 are important design parameters for user convenience, the firefighter respirator mask device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A firefighter respirator mask device that can be used to cover a mouthpiece opening of a SCBA mask, the firefighter respirator mask device comprising:
a color-changing body:
an elastic band;
a front surface;
a rear surface;
at least two looped straps; and
an adhesive layer having a peelable backing.

2. The firefighter respirator mask device of claim 1, wherein the color-changing body changes from a first color to a second color when the color-changing body is exposed to a threshold amount of a pathogen, a virus or a bacteria.

3. The firefighter respirator mask device of claim 1, wherein the at least two looped straps can be removably attached around a filter cover of the SCBA mask

4. The firefighter respirator mask device of claim 1, wherein the peelable backing can be removed from the adhesive layer, and the adhesive layer can be pressed around the mouthpiece opening to secure the firefighter respirator mask device around the mouthpiece opening.

5. The firefighter respirator mask device of claim 1, wherein the firefighter respirator mask device is a reusable mask.

6. A firefighter respirator mask device that can be used to cover a mouthpiece opening of a SCBA mask, the firefighter respirator mask device comprising:
a color-changing body:
an elastic band within the color-changing body that aids the color-changing body in being retained around the mouthpiece opening of the SCBA mask;
a front surface;
a rear surface having an adhesive layer comprised of a peelable backing; and
at least two looped straps that can be removably attached around a filter cover of the SCBA mask, wherein the at least two straps are each further comprised of at least one fastener.

7. The firefighter respirator mask device of claim 6, wherein the at least two straps are comprised of a flexible, flame retardant and acid damage resistant material.

8. The firefighter respirator mask device of claim 6, wherein the peelable backing can be removed from the adhesive layer, and the adhesive layer can be pressed around the mouthpiece opening to secure the firefighter respirator mask device around the mouthpiece opening.

9. The firefighter respirator mask device of claim 6, wherein each of the at least one fastener of the at least two straps aids in retaining the at least two straps around the filter cover of the SCBA mask.

10. The firefighter respirator mask device of claim 9, wherein the at least one fastener is an adhesive fastener, a magnetic fastener or a hook and loop fastener.

11. The firefighter respirator mask device of claim 6, wherein the color-changing body changes from a first color to a second color when the color-changing body is exposed to a threshold amount of a pathogen, a virus or a bacteria.

12. A firefighter respirator mask device that can be used to cover a mouthpiece opening of a SCBA mask, the firefighter respirator mask device comprising:
a color-changing body:
an elastic band within the color-changing body that aids the color-changing body in being retained around the mouthpiece opening of the SCBA mask;
a front surface;
a rear surface having at least one pocket and an adhesive layer having a peelable backing;
at least one filter received by the at least one pocket; and
at least two looped straps that can be removably attached around a filter cover of the SCBA mask, wherein the at least two looped straps are each comprised of at least one fastener.

13. The firefighter respirator mask device of claim 11, wherein the at least two looped straps are comprised of a flexible, flame retardant and acid damage resistant material.

14. The firefighter respirator mask device of claim 11, wherein the peelable backing can be removed from the adhesive layer, and the adhesive layer can be pressed around the mouthpiece opening to secure the firefighter respirator mask device around the mouthpiece opening.

15. The firefighter respirator mask device of claim 11, wherein each of the at least one fastener of the at least two looped straps aids in retaining the at least two looped straps around the filter cover of the SCBA mask.

16. The firefighter respirator mask device of claim 14, wherein the at least one fastener is an adhesive fastener, a magnetic fastener or a hook and loop fastener.

17. The firefighter respirator mask device of claim 11, wherein the color-changing body changes from a first color to a second color when the body is exposed to a threshold amount of a pathogen, a virus or a bacteria.

18. The firefighter respirator mask device of claim 17, wherein the first color is green and the second color is red.

19. The firefighter respirator mask device of claim 11, wherein the at least one filter is a carbon filter or a HEPA filter.

20. The firefighter respirator mask device of claim 15, wherein the at least one filter changes from a first color to a second color when the body is exposed to a threshold amount of a pathogen, a virus or a bacteria
